(19) United States
(12) Patent Application Publication
(10) Pub. No.: US 2020/0027087 A1
(43) Pub. Date: Jan. 23, 2020

(54) METHOD AND SYSTEM FOR PROCESSING DECLINED TRANSACTIONS

(71) Applicant: MASTERCARD INTERNATIONAL INCORPORATED, Purchase, NY (US)

(72) Inventors: Parameswaran Venkatasubramanian, Chennai (IN); Lakshmi Narasimhan Ramanujam, Chennai (IN); Abhishek Chaturvedi, Lucknow (IN)

(21) Appl. No.: 16/427,777

(22) Filed: May 31, 2019

(30) Foreign Application Priority Data
Jul. 20, 2018 (SG) 10201806247Y

(51) Int. Cl. G06Q 20/40; G06Q 20/24

(52) U.S. Cl. CPC G06Q 20/407; G06Q 20/24; G06Q 20/401; G06Q 20/4037

(57) ABSTRACT

A method for processing declined transactions is provided. A transaction decline notification for a transaction performed by a user is received in response to a first authorization request that is communicated to an issuer server. If a credit score of the user is greater than or equal to a threshold value, a data element of the first authorization request, indicating a transaction amount of the transaction, is modified to generate a second authorization request. The modified data element indicates a first amount that is lower than the transaction amount. The second authorization request is communicated to the issuer server and a transaction approval notification is received in response to the second authorization request. The transaction approval notification overrides the transaction decline notification and indicates that the transaction is approved by the issuer server, thereby making the transaction successful.

### CROSS-REFERENCE TO RELATED APPLICATION

This application claims the benefit of, and priority to, Singapore Patent Application No. 10201806247Y filed on Jul. 20, 2018. The entire disclosure of the above application is incorporated herein by reference.

### FIELD

The present disclosure relates to electronic transactions, and, more particularly to a method and a system for processing declined transactions.

### BACKGROUND

This section provides background information related to the present disclosure which is not necessarily prior art.

With the advent of technology, electronic transactions have gained preference over cash-based transactions. Various payment options (such as e-wallets, transaction cards, internet banking, and the like) that enable the electronic transactions have gained popularity in recent years. Use of the aforementioned payment options eliminates the need for users to carry cash for making payments for their purchases.

Transaction cards are one of the most widely accepted payment options for performing electronic transactions. Typically, users use their transaction cards at various terminal devices (such as point-of-sale (POS) devices of various merchants or automated teller machines (ATMs)) to perform the electronic transactions. With the proliferation of the internet and electronic commerce (e-commerce), the users these days use their transaction cards to perform online transactions as well. In general, a transaction card is issued to a user by an issuer bank, where an account of the user is maintained. When the user uses the transaction card to initiate an electronic transaction or an online transaction, details of the transaction card are routed to the issuer bank through a payment network. The issuer bank approves the transaction when an account balance or an available credit line of the user covers a transaction amount of the transaction. However, if the account balance or the available credit line does not cover the transaction amount, the issuer bank declines the transaction due to insufficient funds. The transaction may also be declined if a server system of the issuer bank is not operational or facing a downtime.

Such declined transactions cause great inconvenience to the user and also increases processing overhead of the server systems of the issuer bank and the payment network. In certain cases, the user may fall short of an insignificantly small amount while performing the transaction, but the transaction is still declined by the issuer bank. Additionally, the user may be facing an emergency, for which they need to perform the transaction immediately. In such a scenario, if the transaction is declined, the user may be put in a perilous situation.

A known solution to avoid declined transactions due to insufficient funds is to opt for overdraft services offered by issuer banks. An overdraft service permits a user to borrow funds from the corresponding issuer bank in an event the account balance or the available credit line is falling short to cover the transaction amount. However, to avail such a service, the user must be signed up for the overdraft service with the corresponding issuer bank. Thus, in unforeseen circumstances, when the user has not already signed up for the overdraft service, the user will not be permitted to borrow funds from the issuer bank. In some cases, especially for borrowing large funds, the user may be asked to opt for a secured overdraft service where the user has to pledge an asset as security to avail the secured overdraft service. The user may have an option to opt for an unsecured overdraft service without pledging any asset as security, however, the user will be limited to borrowing small funds. Also, in case of the unsecured overdraft service, the issuer bank is at a risk of incurring a loss if the user is not able to pay back the borrowed funds.

In light of the foregoing, there exists a need for a solution that allows a user to perform a transaction even when the user does not possess sufficient funds to cover a transaction amount for the transaction and ensures that issuer banks do not incur losses due to such transactions.

### SUMMARY

This section provides a general summary of the disclosure, and is not a comprehensive disclosure of its full scope or all of its features. Aspects and embodiments of the disclosure are set out in the accompanying claims.

In an embodiment of the present disclosure, a method for processing declined transactions is provided. A transaction decline notification is received by a first server from a second server in response to a first authorization request that is communicated to the second server for approving a transaction performed by a user. The transaction decline notification includes a first data element that indicates a transaction amount of the transaction. The transaction decline notification indicates that the transaction is declined. A credit score of the user is retrieved by the first server from a database based on the transaction decline notification. A first data element of the first authorization request is modified to generate a second authorization request when the credit score is greater than a threshold value. The modified first data element indicates a first amount that is lower than the transaction amount. The second authorization request is communicated to the second server. A transaction approval notification is received in response to the second authorization request. The transaction approval notification overrides the transaction decline notification and indicates that the transaction is approved by the second server, thereby making the transaction successful.

In another embodiment of the present disclosure, a system for processing declined transactions is provided. The system includes a first server that includes a processor. The processor receives a transaction decline notification from a second server in response to a first authorization request that is communicated to the second server for approving a transaction performed by a user. The first authorization request includes a first data element that indicates a transaction amount of the transaction. The transaction decline notification indicates that the transaction is declined. The processor retrieves a credit score of the user from a database based on the transaction decline notification. The processor modifies the first data element of the first authorization request for the transaction when the credit score is greater than a threshold value. The modified first data element indicates a first amount that is lower than the transaction amount. The processor communicates the second authorization request to the second server. The processor receives a transaction approval notification from the second server in response to the second authorization request. The transaction approval notification overrides the transaction decline notification and indicates that the transaction is approved by the second server, thereby making the transaction successful.

In yet another embodiment of the present disclosure, a method for processing declined transactions is provided. A first authorization request for a transaction performed by a user is communicated to an issuer server by a payment network server. The first authorization request includes a first data element that indicates a transaction amount of the transaction. A transaction decline notification is received by the payment network server in response to the first authorization request. The transaction decline notification indicates that the transaction is declined due to insufficient account balance or available credit line of an account that corresponds to the transaction. A credit score of the user is retrieved by the payment network server from a database based on the transaction decline notification. The first data element of the first authorization request is modified by the payment network server to generate a second authorization request for the transaction, when the credit score is greater than or equal to a threshold value. The modified first data element indicates a first amount that is lower than the transaction amount. The second authorization request is communicated by the payment network server to the issuer server. A transaction approval notification is received from the issuer server by the payment network server in response to the second authorization request. The transaction approval notification indicates that the transaction is approved by the issuer server and overrides the transaction decline notification, thereby making the transaction successful.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. In connection therewith, the accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates a communication environment for processing declined transactions, in accordance with an embodiment of the present disclosure;

FIG. 2 is a block diagram that illustrates a payment network server of the communication environment of FIG. 1, in accordance with an embodiment of the present disclosure;

FIG. 3 is a block diagram that illustrates an exemplary scenario for processing declined transactions, in accordance with an embodiment of the present disclosure;

FIG. 4 is a block diagram that illustrates another exemplary scenario for processing declined transactions, in accordance with another embodiment of the present disclosure;

FIG. 5 is a block diagram that illustrates yet another exemplary scenario of processing declined transactions, in accordance with yet another embodiment of the present disclosure;

FIGS. 6A and 6B, collectively represent a flow chart that illustrates a method for processing declined transactions, in accordance with an embodiment of the present disclosure;

FIG. 7 represents a high-level flow chart that illustrates a method for processing declined transactions, in accordance with an embodiment of the present disclosure;

FIG. 8 represents a high-level flow chart that illustrates the method for processing declined transactions, in accordance with another embodiment of the present disclosure; and

FIG. 9 is a block diagram that illustrates system architecture of a computer system, in accordance with an embodiment of the present disclosure.

Again, corresponding reference numerals indicate corresponding parts throughout the several views of the drawings.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

Embodiments will be described, by way of example only, with reference to the drawings. The description and specific examples included herein are intended for purposes of illustration only and are not intended to limit the scope of the present disclosure. The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the present disclosure provide a method and a system for processing declined transactions. A user performs a transaction for a transaction amount from their bank account that is maintained with an issuer bank. In one scenario, the transaction is an electronic transaction performed at a terminal device, such as an automated teller machine (ATM) or a point-of-service (POS) device). In another scenario, the transaction is an online transaction performed by using a user device. A first server (such as a payment network server) receives a first authorization request that corresponds to the transaction. The first authorization request is pursuant to one or more standards for the interchange of transaction messages, such as the ISO8583 standard, and includes various data elements. A first data element is one such data element of the first authorization request, which indicates the transaction amount of the transaction that is to be billed to a user account of the user. The first server transmits the first authorization request to a second server (such as an issuer server) for approving the transaction. For approving the transaction, the second server checks whether an account balance or an available credit line of the bank account that corresponds to the transaction covers the transaction amount indicated by the first data element. In a scenario, when the account balance or the available credit line do not cover the transaction amount, the second server transmits a transaction decline notification in response to the first authorization request to the first server. The transaction decline notification is pursuant to one or more standards for the interchange of transaction messages, such as the ISO8583 standard, and includes various data elements. A second data element is one such data element included by the transaction decline notification. In one scenario, the second data element indicates the account balance or the available credit line of the bank account. In another scenario, the second data element is an empty field.

Based on the transaction decline notification, the first server derives that the transaction is declined due to insufficient funds in the bank account of the user. The first server then retrieves a credit score, such as a Credit Information Bureau (India) Limited (CIBIL) score, Fair, Isaac, and Company (FICO) score, or the like, of the user from a credit score database. The first server compares the credit score of the user with a threshold value. The threshold value is defined by the first server based on one or more parameters, such as previous interaction of the user with the first server, or the like. If the credit score of the user is greater than or equal to the threshold value, the first server modifies the first data element of the first authorization request to generate a second authorization request. The modified data element indicates a first amount that is lower than the transaction amount. The first amount is one of the account balance, the available credit line, or a nominal amount (i.e., a low amount, $0.01) defined by the first server that is independent of the account balance or the available credit line.

The first server transmits the second authorization request to the second server. Since the modified first data element now indicates one of the account balance, the available credit line, or the nominal amount, the second server approves the transaction and transmits a transaction approval notification to inform the first server that the transaction has been approved. The user is also notified that the transaction is successful. The first server settles the transaction for the transaction amount with the issuer bank and an acquirer bank after a specific time-interval. The user is accountable for maintaining an amount that is equivalent to the transaction amount in the bank account before the settlement of the transaction.

Thus, the method and the system of the present disclosure allows the user to perform the transaction even when the account balance or the available credit line does not cover the transaction amount. As the first data element is modified only if the credit score of the user is greater than or equal to the threshold value, the risk of incurring loss by the issuer bank is reduced. The method and system of the present disclosure further reduces a count of transactions that are declined due to insufficient funds, thereby reducing a processing overhead of the first and second servers caused due to the declined transactions.

Account refers to a financial account that is used to fund transactions. Examples of the account include, but are not limited to, a savings account, a credit account, a checking account, or a digital wallet. The account is associated with an entity, such as an individual person, a family, a commercial entity, a company, a corporation, a governmental entity, a non-profit organization, or the like. In this scenario, the entity corresponds to an account holder of the account.

Transaction card includes a payment device, such as a debit card, a credit card, a prepaid card, a gift card, a promotional card, a contactless card, an electronic cash card, and/or any other device that is linked to an account and holds identification information of the account. The transaction card can be used to perform transactions, such as deposits and withdrawals, credit transfers, purchase payments, and the like, from the account to which it is linked. The transaction card can be a physical card or a virtual card that is electronically stored in a user device. The transaction card may be radio frequency identification (RFID) or near field communication (NFC) enabled for performing contactless payments.

A POS device, a point-of-interaction (POI) device, a point-of-purchase (POP) device, and an NFC-POS device are terminal devices installed within retail establishments, such as merchant stores, for facilitating electronic transactions.

An ATM is a terminal device affiliated with a financial institution, such as a bank (hereinafter “acquirer bank”). The ATM enables a user to perform various electronic transactions, such as cash withdrawals, and the like.

Merchant is an entity that offers various products and/or services in exchange for payments. The merchant may establish a merchant account with a financial institution, such as an acquirer bank, to accept the payments from several users by use of one or more payment methods.

Issuer or issuer bank is a financial institution, such as a bank, where accounts of several users are established and maintained. The issuer bank ensures payment for authorized transactions in accordance with various payment network regulations and local legislation.

Payment network is an institution that acts as an intermediate entity between acquirer banks and issuer banks to authorize and fund transactions. Examples of payment networks include MasterCard®, American Express®, VISA®, Discover®, Diners Club®, and the like. The payment network settles the transactions between various acquirer banks and issuer banks, when transaction cards are used for initiating transactions. The payment network authorizes transactions performed by use of transaction cards.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of a payment network server, an issuer server, an acquirer server, or a merchant server.

Authorization request is a request that is pursuant to one or more standards for the interchange of transaction messages, such as the ISO8583 standard. The authorization request is generated to validate a transaction performed by a user. Based on the authorization request, an issuer bank that corresponds to the transaction approves or declines the transaction. The authorization request includes various data elements indicating details of a transaction, such as an amount to be billed to a user account of the user who performed the transaction, an amount to be credited in a merchant account of a merchant for the transaction, details of the user account, details of the merchant account, a timestamp of the transaction, a transaction ID of the transaction, and the like.

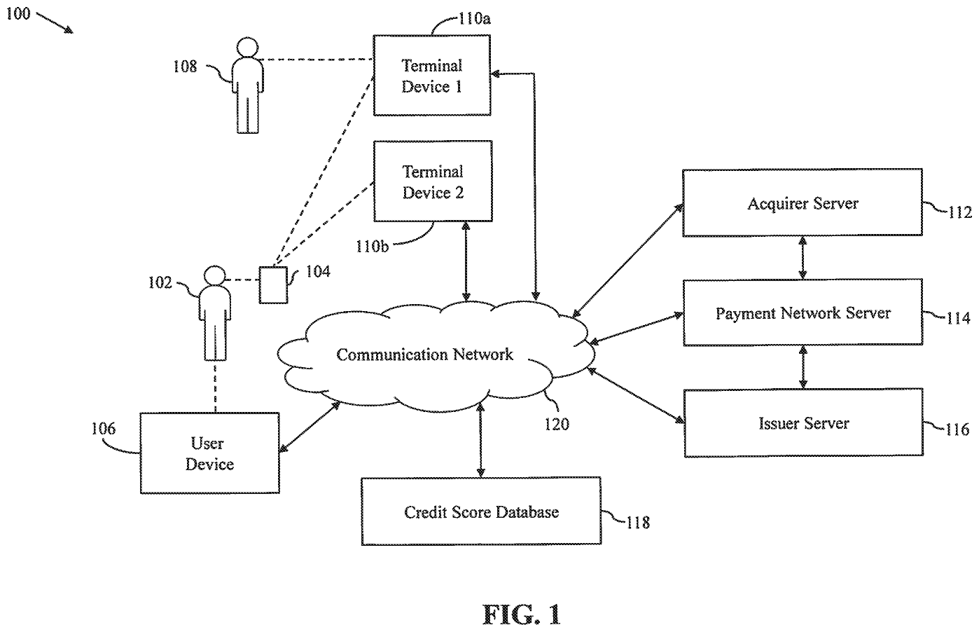

FIG. 1 is a block diagram that illustrates a communication environment 100 for processing declined transactions, in accordance with an embodiment of the present disclosure. The communication environment 100 includes a user 102, who possesses a transaction card 104 and a user device 106, and a merchant 108 associated with a merchant store (not shown) where a first terminal device 110a is installed. The communication environment 100 also includes a second terminal device 110b, an acquirer server 112, a payment network server 114, an issuer server 116, and a credit score database 118. The user device 106, the first and second terminal devices 110a and 110b, the acquirer server 112, the payment network server 114, the issuer server 116, and the credit score database 118 communicate with each other by way of a communication network 120 or through separate communication networks established there between.

The user 102 is an individual, who is an account holder of a user account. The user account is a bank account maintained by a financial institution, such as an issuer bank. The issuer bank may have issued the transaction card 104 to the user 102 for performing transactions from the user account. The transaction card 104 is linked to the user account and stores identification information of the user account (hereinafter referred to as “account information” of the user account) in the form of an electronic chip or a machine readable magnetic strip. The account information may include an account number, a name of an account holder (i.e., the user 102), or the like. The transaction card 104 further has a unique card number, an expiry date, a card security code, and a card type associated with it. The unique card number, the expiry date, the card security code, and the card type constitute transaction card details of the transaction card 104. In one embodiment, the transaction card 104 is a physical card. In another embodiment, the transaction card 104 is a virtual card or a payment token that is stored electronically in a memory (not shown) of the user device 106. Examples of the transaction card 104 include a credit card, a debit card, a membership card, a promotional card, a charge card, a prepaid card, a gift card, an electronic cash card, or the like.

The user device 106 is a communication device of the user 102. In one embodiment, the user device 106 is used by the user 102 for performing online transactions from the user account. For example, the user 102 accesses a merchant website or a merchant application of the merchant 108 by way of the user device 106 and performs an online transaction to purchase a product from the merchant website or the merchant application. Examples of the user device 106 include, but are not limited to, mobile phones, smartphones, laptops, tablets, phablets, or any other communication devices. The user device 106 may be associated with a mobile number or an electronic mail (e-mail) ID that is linked to the user account of the user 102.

The merchant 108 is an entity typically represented by an individual that offers goods and/or services to users (such as the user 102) in exchange for payments. The merchant 108 is associated with an acquirer bank and has established a merchant account therein. The first terminal device 110a is an electronic device installed at the merchant store of the merchant 108 by the acquirer bank. The users (such as the user 102) use the first terminal device 110a to perform transactions corresponding to the purchases they make from the merchant 108. In one embodiment, when the user 102 uses the transaction card 104 to perform a transaction at the first terminal device 110a, the first terminal device 110a reads the account information and the transaction card details held by the transaction card 104. In another embodiment, when the user 102 uses the user device 106, having the transaction card details of the transaction card 104 stored thereon, to perform the transaction at the first terminal device 110a, the first terminal device 110a receives the transaction card details from the user device 106. In yet another embodiment, the first terminal device 110a may support cardless transactions as known to those of skill in the art. When the transaction is performed at the first terminal device 110a, the first terminal device 110a encrypts transaction details and communicates the encrypted transaction details to the acquirer server 112 of the acquirer bank that has installed the first terminal device 110a at the merchant store. The transaction details include the transaction card details, the account information, a transaction amount, a merchant identification code of the merchant 108, a timestamp of the transaction, a transaction ID of the transaction, and the like. Once the transaction is approved by the issuer bank of the user 102, the first terminal device 110a notifies the user 102 that the transaction is successful. Examples of the first terminal device 110a include, but are not limited to, a point-of-sale (POS) device, a point-of-interaction (POI) device, and a point-of-purchase (POP) device.

The second terminal device 110b is an electronic device, which users (such as the user 102) perform transactions from the corresponding user accounts. The second terminal device 110b is an automated teller machine (ATM) associated with a financial institution, such as the acquirer bank. When the transaction is performed at the second terminal device 110b, the second terminal device 110b encrypts the transaction details and communicates the encrypted transaction details to the acquirer server 112 of the acquirer bank. Once the transaction is approved by the issuer bank of the user 102, the second terminal device 110b notifies the user 102 that the transaction is successful. In one exemplary scenario, the user 102 may perform an electronic transaction at the second terminal device 110b to withdraw cash from the user account. In such a scenario, when the transaction is approved by the issuer bank, the second terminal device 110b dispenses cash equivalent to the transaction amount of the transaction.

The acquirer server 112 is a computing server that is associated with the acquirer bank. The acquirer bank maintains the merchant account of the merchant 108. The acquirer bank processes encrypted transaction details received from the first and second terminal devices 110a and 110b by using the acquirer server 112. The acquirer server 112 transmits authorization requests to payment networks or issuer banks associated with user accounts from which the corresponding transactions are initiated, via the communication network 120. The acquirer server 112 transmits an authorization request corresponding to a transaction for determining whether the corresponding account holder's available credit line or account balance covers the transaction amount of the transaction. The authorization request includes various data elements that represent the transaction details of the transaction and are pursuant to one or more standards for the interchange of transaction messages, such as the ISO8583 standard. A first data element (such as DE6 as per the ISO8583 standard) is one such data element included in the authorization request, which indicates the transaction amount of the transaction. The transaction amount indicated by the first data element is billed to the corresponding user account when the transaction is approved. The authorization request may also include a second data element (such as DE4 as per the ISO8583 standard). In one embodiment, when the transaction is associated with a purchase made from the merchant 108, the second data element indicates an amount that is to be credited to the merchant account of the merchant 108 when the transaction is settled. In another embodiment, when the transaction is for withdrawing cash from an ATM, the second data element indicates an amount that is to be credited to the acquirer bank associated with the transaction. The acquirer server 112 credits or debits merchant accounts maintained with the acquirer bank based on settlement of the corresponding transactions.

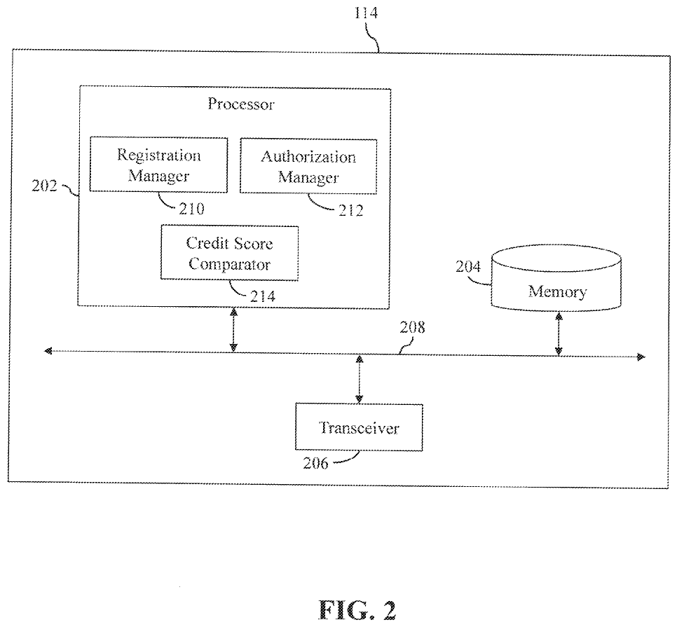

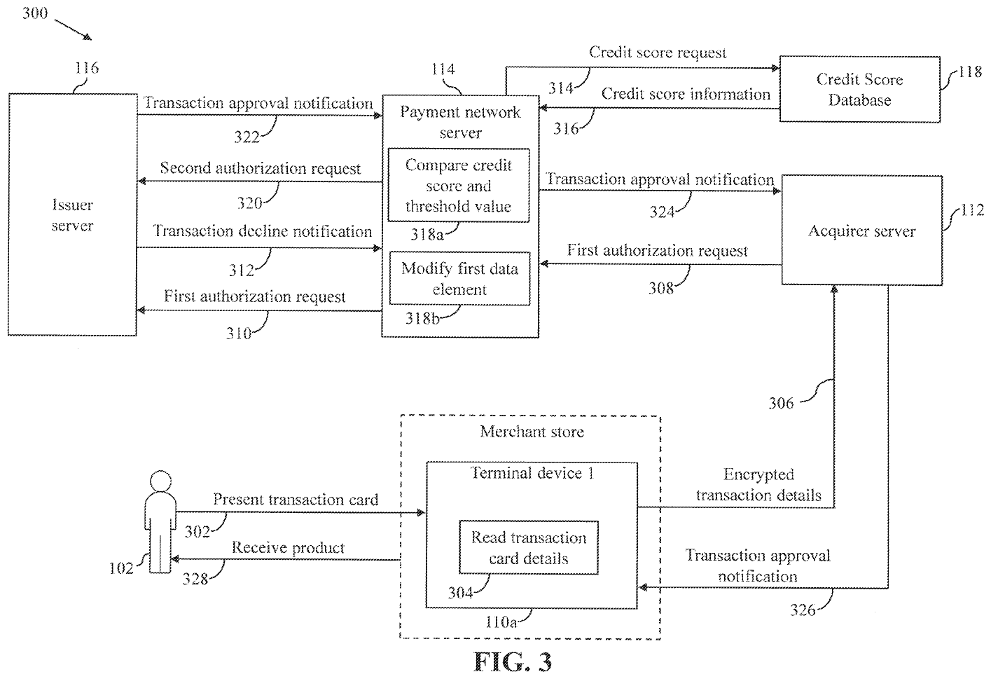

The payment network server 114 is a computing server that is associated with a payment network of various transaction cards, such as the transaction card 104. The payment network server 114 represents an intermediate entity between the acquirer server 112 and the issuer server 116 for authorizing and funding the transactions performed at the first and second terminal devices 110a and 110b by using the transaction cards, such as the transaction card 104. In one scenario, the payment network server 114 is a payment processing server. The payment network server 114 receives the authorization requests from the first and second terminal devices 110a and 110b and the acquirer server 112, and routes the authorization requests to corresponding issuer servers, such as the issuer server 116, for processing. Further, the payment network provides an overdraft service to account holders of partner issuer banks by way of the payment network server 114. By way of the overdraft service, the payment network server 114 processes the transactions that are declined by the partner issuer banks due to insufficient funds in the user accounts that correspond to the transactions. The processing of such declined transactions is based on credit scores of the account holders of the user accounts that correspond to the declined transactions. The overdraft service offered by the payment network server 114 is explained in detail in conjunction with FIGS. 3, 4, and 5. Examples of various payment networks include MasterCard®, American Express®, VISA®, Discover®, Diners Club®, or the like. Elements of the payment network server 114 are explained in detail in conjunction with FIG. 2.

The issuer server 116 is a computing server that is associated with the issuer bank. The issuer bank is a financial institution that manages user accounts of multiple users. Account details of the user accounts, such as the user account of the user 102, established with the issuer bank are stored as account profiles in a memory (not shown) of the issuer server 116 or on a cloud server associated with the issuer server 116. The account details may include an account balance, an available credit line, details of an account holder, transaction history of the account holder, account information, or the like. The details of the account holder may include name, age, gender, physical attributes, registered contact number, alternate contact number, registered e-mail ID, or the like of the account holder. Methods for processing transactions via the issuer server 116 will be apparent to persons having skill in the art and may include processing a transaction via the traditional four-party system or the traditional three-party system.

The credit score database 118 is a database that may be maintained at a database server (not shown) that stores credit scores of multiple users, such as the user 102. In one example, the credit score database 118 is maintained by a credit bureau of a region. The credit bureau determines the credit score of each user based on a credit history of the corresponding user. For example, the credit history of a user includes past loans, credit card bill payments, an annual income of the corresponding user, and the like. In one example, the credit score is a numerical value that lies between 200 and 900, where a higher credit score indicates a better credit history of the corresponding user. Various credit rating systems are well known in the art and their further description is avoided for the sake of brevity.

Examples of the acquirer server 112, the payment network server 114, the issuer server 116, and the credit score database 118 include, but are not limited to, computers, laptops, mini-computers, mainframe computers, any non-transient and tangible machines that can execute a machine-readable code, cloud-based servers, distributed server networks, a network of computer systems, or a combination thereof.

The communication network 120 is a medium through which content and messages are transmitted between the user device 106, the first and second terminal devices 110a and 110b, the acquirer server 112, the payment network server 114, the issuer server 116, the credit score database 118, or other entities that are pursuant to one or more standards for the interchange of transaction messages, such as the ISO8583 standard. Examples of the communication network 120 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the communication environment 100 may connect to the communication network 120 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

FIG. 2 is a block diagram that illustrates the payment network server 114, in accordance with an embodiment of the present disclosure. The payment network server 114 includes a processor 202, a memory 204, and a transceiver 206 that communicate with each other via a bus 208.

The processor 202 includes suitable logic, circuitry, and/or interfaces to execute operations for processing transactions based on various requests that are received from one or more entities, such as the first and second terminal devices 110a and 110b, the acquirer server 112, or the issuer server 116. Examples of the processor 202 include, but are not limited to, an application-specific integrated circuit (ASIC) processor, a reduced instruction set computing (RISC) processor, a complex instruction set computing (CISC) processor, a field-programmable gate array (FPGA), and the like. The processor 202 executes the operations for processing transactions by way of a registration manager 210, an authorization manager 212, and a credit score comparator 214. The registration manager 210, the authorization manager 212, and the credit score comparator 214 includes suitable logic, circuitry, and/or interfaces to execute operations for processing the transactions.

The registration manager 210 performs various operations for registering the users (such as the user 102), who have user accounts in the partner issuer banks, for the overdraft service offered by the payment network. In one embodiment, the process of registering the user 102 is carried out by way of an application interface (such as a mobile application or a web-based application) hosted by the payment network server 114. The user 102 may access the application interface on the user device 106 to register for the overdraft service. During registration, the user 102 provides their details, such as account details, age, gender, registered contact number, alternate contact number, registered e-mail ID, or the like. Based on the details of the user 102, the registration manager 210 creates a user profile of the user 102 and stores the user profile in the memory 204. In another embodiment, the registration manager 210 automatically registers the users (such as the user 102), who have accounts in the partner issuer banks, for the overdraft service based on their consent obtained at the time of establishing their accounts with the partner issuer banks. In such a scenario, the registration manager 210 retrieves the details of the user 102 from the corresponding issuer bank for creating the user profile. Once the user 102 is registered, the registration manager 210 notifies the user 102 regarding the successful registration for the overdraft service.

The authorization manager 212 handles various authorization requests received from the acquirer server 112. When an authorization request for a transaction performed by the user 102 is received by the authorization manager 212 from the acquirer server 112, the authorization manager 212 identifies the issuer bank that maintains the user account of the user 102 from which the transaction is performed. The authorization manager 212 then communicates the authorization request to the issuer server (such as the issuer server 116) of the identified issuer bank for authorizing the transaction. In one embodiment, when the issuer server 116 declines the transaction due to insufficient funds in the user account and transmits a transaction decline notification to the payment network server 114, the authorization manager 212 retrieves a credit score of the user 102 from the credit score database 118.

The credit score comparator 214 compares the credit score of the user 102 with a threshold value. The threshold value is defined by the authorization manager 212 based on an agreement with the partner issuer banks. In one embodiment, the threshold value is different for different users based on their previous interactions with the corresponding issuer banks and the payment network. The credit score comparator 214 may set or reset a comparison flag indicating the result of the comparison. For example, if the result of the comparison indicates that the credit score of the user 102 is greater than or equal to the threshold value, the credit score comparator 214 sets the comparison flag to ‘1’, else the credit score comparator 214 resets the comparison flag to ‘0’.

Based on the value of the comparison flag, the authorization manager 212 makes a decision whether to modify the transaction amount (i.e., the amount which is to be billed to the user account of the user 102) indicated by the authorization request. When the comparison flag is set to ‘1’, the authorization manager 212 replaces the transaction amount with a first amount that is less than the transaction amount to generate a modified authorization request for the transaction. The first amount is a nominal value defined by the authorization manager 212 such that the user account has enough funds to cover the first amount. In one example, the first amount is the account balance or the available credit line of the user account. In another example, the first amount is a very low amount, such as $0.01, defined by the authorization manager 212. The authorization manager 212 then transmits the modified authorization request to the issuer server 116 for further processing. Since the user account has enough funds to cover the first amount, the issuer server 116 approves the transaction by transmitting a transaction approval notification which is then communicated to the acquirer server 112 for completing the transaction performed by the user 102.

The memory 204 includes suitable logic, circuitry, and/or interfaces to store details of various issuer banks and acquirer banks, which are participating members of the payment network. The memory 204 stores the user profiles of the users who are registered for the overdraft service. The memory 204 also stores the threshold values corresponding to the users who are registered for the overdraft service. Examples of the memory 204 include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the memory 204 in the payment network server 114, as described herein. In other embodiments, the memory 204 may be realized in the form of a database server or a cloud storage working in conjunction with the payment network server 114, without departing from the scope of the disclosure.

The transceiver 206 transmits and receives data over the communication network 120 using one or more communication network protocols. The transceiver 206 transmits/receives various requests and messages to/from at least one of the first and second terminal devices 110a and 110b, the acquirer server 112, the issuer server 116, or other entities that are pursuant to one or more standards for the interchange of transaction messages, such as the ISO8583 standard. Examples of the transceiver 206 include, but are not limited to, an antenna, a radio frequency transceiver, a wireless transceiver, a Bluetooth transceiver, an Ethernet based transceiver, a universal serial bus (USB) transceiver, or any other device configured to transmit and receive data.

Various functions performed by the payment network server 114 for processing declined transactions are explained in conjunction with FIGS. 3, 4, and 5.

FIG. 3 is a block diagram that illustrates an exemplary scenario 300 for processing a declined transaction using the communication environment 100 of FIG. 1, in accordance with an embodiment of the present disclosure. The exemplary scenario 300 illustrates the user 102, who wishes to purchase a product that is for sale at the merchant store of the merchant 108.

To perform a transaction for purchasing the product, the user 102 presents the transaction card 104 to the merchant 108 (as shown by arrow 302). It will be apparent to those of skill in the art that the user 102 may use any other payment mode accepted by the merchant 108 for performing the transaction, without deviating from the scope of the disclosure. The merchant 108 inputs a transaction amount (i.e., a price of the product, $1,000) payable by the user 102 for the purchase and uses the transaction card 104 at the first terminal device 110a (for example, a POS device 110a). The POS device 110a reads the transaction card details and the account information held by the transaction card 104 (as shown by block 304). The POS device 110a then prompts the user 102 to provide an authentication password, such as a one-time-password (OTP), a personal identification number (PIN) of the transaction card 104, or the like. The user 102 then inputs the authentication password in the POS device 110a.

The POS device 110a encrypts transaction details of the transaction and transmits the encrypted transaction details to the acquirer server 112 (as shown by arrow 306). The encrypted transaction details include the transaction card details, the account information, the transaction amount, the merchant identification code of the merchant 108, a timestamp of the transaction, a transaction ID of the transaction, the authentication password, or the like. Based on the encrypted transaction details, the acquirer server 112 generates a first authorization request that is pursuant to one or more standards for the interchange of transaction messages, such as the ISO8583 standard. The first authorization request includes the first data element (i.e., DE6) that indicates the transaction amount (i.e., $1,000) payable by the user 102 and the second data element (i.e., DE4) that indicates an amount that the merchant 108 is supposed to receive when the transaction is settled.

The acquirer server 112 routes the first authorization request to the payment network server 114 (as shown by arrow 308). The authorization manager 212 identifies the issuer bank associated with the user account of the user 102 based on the account information and the transaction card details included in the first authorization request. The transceiver 206 transmits the first authorization request to the issuer server 116 associated with the identified issuer bank (as shown by arrow 310).

Based on the authentication password included in the first authorization request, the issuer server 116 authenticates the user 102. If the authentication of the user 102 is successful, the issuer server 116 determines the account balance or the available credit line linked to the user account that corresponds to the transaction. The issuer server 116 checks whether the account balance or the available credit line is sufficient to cover the transaction amount (i.e., $1,000) indicated by the first data element. In one scenario, if the account balance or the available credit line covers the transaction amount, the issuer server 116 approves the transaction. In another scenario, if the account balance or the available credit line does not cover the transaction amount, the issuer server 116 declines the transaction. The exemplary scenario 300 illustrates the scenario where the issuer server 116 determines that the account balance or the available credit line does not cover the transaction amount. For example, the issuer server 116 determines that the account balance of the user account is $800, which does not cover the transaction amount of $1,000. The issuer server 116 transmits a transaction decline notification to the payment network server 114 to indicate that the transaction has been declined (as shown by arrow 312). In one embodiment, the transaction decline notification indicates a reason for declining the transaction, for example, insufficient funds. The transaction decline notification is pursuant to one or more standards for the interchange of transaction messages, such as the ISO8583 standard. In one embodiment, the transaction decline notification includes a third data element (such as DE95 of the ISO8583 standard). In one scenario, the third data element indicates the account balance or the available credit line of the user account. In another embodiment, the third data element is an empty field. It will be apparent to those having ordinary skill in the art that the third data element may or may not include the account balance or the available credit line based on the discretion of the issuer server 116. In a non-limiting example, it is assumed that the transaction decline notification includes the reason for declining the transaction and the third element is populated with the account balance (i.e., $800) of the user account.

The transceiver 206 receives the transaction decline notification from the issuer server 116. The authorization manager 212 derives the reason behind the decline of the transaction from the transaction decline notification. In one scenario where the transaction is declined for any reason other than insufficient funds, the transceiver 206 transmits the transaction decline notification to the acquirer server 112. The acquirer server 112 then transmits the transaction decline notification to the POS device 110a to notify the user 102 that the transaction is declined.

In the current exemplary scenario, as the transaction is declined due to insufficient funds, the registration manager 210 identifies whether the user 102 has been registered for the overdraft service offered by the payment network. In a non-limiting example, it is assumed that the user 102 is registered for the overdraft service. The authorization manager 212 determines an overdraft amount for the transaction. The overdraft amount is an amount that the user 102 is falling short of for the transaction and corresponds to a difference between the transaction amount and the amount indicated by the third data element of the transaction decline notification. In this example, the third data element is populated with the account balance (i.e., $800), thus the overdraft amount is equivalent to $200 (i.e., $1,000−$800=$200).

Upon determining the overdraft amount, the authorization manager 212 retrieves a threshold value, which corresponds to the overdraft amount, from a list of threshold values stored in the memory 204. In one non-limiting scenario, each threshold value in the list of threshold values is mapped to a specific range of overdraft amounts. For example, the list of threshold values includes the threshold values such as “400”, “450”, “500”, “600”, and “750”, that are mapped to the ranges of overdraft amounts such as “$100-$150”, “$151-$300”, “$301-$500”, “$501-$700”, and “$701-$1,200”, respectively. In this scenario, the overdraft amount is equivalent to $200, thus the threshold value retrieved from the list of threshold values is “450”.

The authorization manager 212 then transmits a credit score request to the credit score database 118 to retrieve the credit score of the user 102 (as shown by arrow 314). The credit score database 118 transmits credit score information including the credit score of the user 102 to the payment network server 114 in response to the credit score request (as shown by arrow 316). For example, the credit score of the user 102 is “560”. The transceiver 206 receives the credit score information. The credit score comparator 214 compares the credit score (i.e., “560”) with the retrieved threshold value (i.e., “450”) (as shown by block 318a) and sets or resets the comparison flag based on the comparison. If the comparison flag is set to ‘1’ (i.e., the credit score of the user 102 is greater than or equal to the retrieved threshold value), the authorization manager 212 establishes that the user 102 is qualified to avail the overdraft service. If the comparison flag is reset to ‘0’ (i.e., the credit score of the user 102 is less than the corresponding threshold value), the authorization manager 212 establishes that the user 102 is not qualified to avail the overdraft service. In the present scenario, the credit score of the user 102 is “560” and the threshold value is “450”, therefore the credit score comparator 214 sets the comparison flag to ‘1’. Thus, the user 102 qualifies for the overdraft service.

When the user 102 is qualified for the overdraft service, the authorization manager 212 modifies the first data element of the first authorization request (as shown by block 318b) and generates a second authorization request. The authorization manager 212 modifies the first data element such that the modified first data element indicates the first amount that is lower than the transaction amount. The first amount is one of a nominal amount (such as $0.01) defined by the payment network server 114 to ensure that the transaction is approved, or the account balance or the available credit line indicated by the third data element of the transaction decline notification. In this scenario, the third data element of the transaction decline notification indicates the account balance (i.e., $800) of the user account, thus the first amount is the account balance. In other words, the authorization manager 212 replaces the transaction amount ($1,000) with the first amount (i.e., $800) to generate the second authorization request. All other transaction details of the second authorization request, including the second data element (i.e., DE4), remain the same as those of the first authorization request.

The transceiver 206 transmits the second authorization request to the issuer server 116 (as shown by arrow 320). Based on the second authorization request, the issuer server 116 determines whether the account balance or the available credit line of the user account covers the first amount indicated by the first data element of the second authorization request. Since the account balance or the available credit line of the user account covers the first amount indicated by the first data element, the issuer server 116 approves the transaction. The issuer server 116 then transmits a transaction approval notification to the payment network server 114 indicating that the transaction is approved (as shown by arrow 322). Since the transaction ID of the second authorization request remains the same as that of the first authorization request, the transaction approval notification overrides the transaction decline notification that was previously received by the transceiver 206. The authorization manager 212 further flags the transaction as an overdraft transaction. In one embodiment, when the transaction is flagged as the overdraft transaction, the authorization manager 212 modifies the credit score of the user 102 stored in the credit score database 118 in a way that the credit score becomes less than the lowest value in the list of threshold values. For example, the authorization manager 212 decrements the credit score from “560” to “390”, which is less than the lowest threshold value “400” in the list of threshold values. In another embodiment, when the transaction is flagged as the overdraft transaction, the authorization manager 212 sets an overdraft flag (or an overdraft indicator) to ‘1’ for the user 102. The overdraft flag (or the overdraft indicator), when set to ‘1’, indicates that the user 102 has already availed the overdraft service, and hence is not eligible for the overdraft service for any other transaction until the previous overdraft transaction is settled. By modifying the credit score of the user 102 or setting the overdraft flag (or the overdraft indicator) for the user 102 to ‘1’, the payment network server 114 prevents the misuse of the overdraft service by the user 102.

The payment network server 114 routes the transaction approval notification to the acquirer server 112 by way of the transceiver 206 (as shown by arrow 324). The acquirer server 112 considers the transaction approval notification as a response to the first authorization request that the acquirer server 112 had transmitted to the payment network server 114. The acquirer server 112 then transmits the transaction approval notification to the POS device 110a (as shown by arrow 326). The merchant 108 and the user 102 are thus notified that the transaction is successful. The user 102 receives the product from the merchant 108 (as shown by arrow 328).

In one embodiment, the authorization manager 212 transmits a message to the issuer server 116 for indicating that the transaction is an overdraft transaction and the user 102 is liable to maintain the transaction amount (i.e., $1,000) in the user account at the time of the settlement of the transaction. The message includes a schedule for settling the transaction. The issuer server 116 may communicate the schedule to the user 102 as well. In one scenario, the schedule indicates a time period after which the transaction will be settled. The time period is defined based on an agreement between the payment network and the issuer bank. A fee may be levied to the user 102 if the user 102 fails to maintain the transaction amount in the user account at the time of settling the transaction. Further, if the user 102 attempts to avail the overdraft service for another transaction before the settlement of the previous overdraft transaction, the authorization manager 212 declines the privilege of availing the overdraft service to the user 102. In one embodiment, the authorization manager 212 declines the privilege of availing the overdraft service to the user 102 as the credit score stored in the credit score database 118 is less than the retrieved threshold value. In another embodiment, the authorization manager 212 declines the privilege of availing the overdraft service to the user 102 as the overdraft flag (or the overdraft indicator) is set to ‘1’.

Based on an agreement between the merchant 108 and the acquirer bank, the acquirer server 112 initiates a settlement of the transaction. To initiate the settlement, the acquirer server 112 transmits a settlement request to the payment network server 114. The payment network server 114 transmits the settlement request to the issuer server 116 as per the schedule. The issuer server 116 debits the transaction amount from the user account and notifies the payment network server 114. In one embodiment, when the payment network server 114 is notified that the user 102 has paid the transaction amount for settling the transaction, the authorization manager 212 modifies the credit score of the user 102 stored in the credit score database 118 to restore its previous value, thereby making the user 102 eligible for the overdraft service. In another embodiment, when the payment network server 114 is notified that the user 102 has paid the transaction amount, the authorization manager 212 resets the overdraft flag (or the overdraft indicator) to ‘0’. The overdraft flag (or the overdraft indicator), when reset to ‘0’, indicates that the user 102 is eligible for the overdraft service. The payment network server 114 communicates a settlement response to the acquirer server 112 indicating that the transaction amount is debited from the user account. Based on the settlement response, the acquirer server 112 credits the amount indicated by the second data element (i.e., DE4) to the merchant account of the merchant 108.

In one embodiment, when the merchant account and the user account are associated with the same bank, the functionalities of the acquirer server 112 and the issuer server 116 may be performed by a single entity without deviating from the scope of the disclosure. In one embodiment, the authorization manager 212 maintains a list of users (i.e., a list of elite users) in the memory 204 for whom the credit score value is greater than a specific value. For example, the list of elite users includes users who have credit scores greater than 700. Thus, if the issuer server 116 declines a transaction performed by any user from the list of elite users due to insufficient funds, the payment network server 114 bypasses the step of retrieving the corresponding credit score from the credit score database 118 and modifies the first data element for processing the declined transaction.

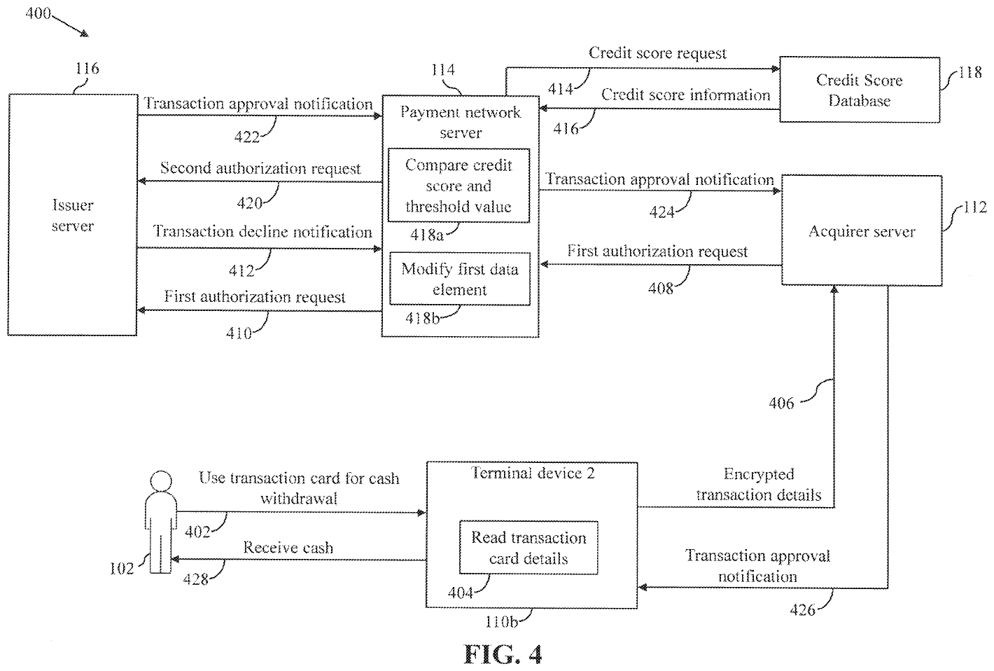

FIG. 4 is a block diagram that illustrates another exemplary scenario 400 for processing a declined transaction using the communication environment 100 of FIG. 1, in accordance with another embodiment of the present disclosure. The exemplary scenario 400 illustrates the user 102, who wishes to withdraw cash from the user account. To perform a transaction for withdrawing cash, the user 102 inputs a transaction amount (for example, $800) and uses the transaction card 104 at the second terminal device 110b, i.e., an ATM 110b, (as shown by arrow 402). The ATM 110b reads the transaction card details and the account information held by the transaction card 104 (as shown by block 404). The ATM 110b then prompts the user 102 to provide the authentication password. The user 102 inputs the authentication password in the ATM 110b.

The ATM 110b encrypts the transaction details of the transaction and transmits the encrypted transaction details to the acquirer server 112 (as shown by arrow 406). The encrypted transaction details include the transaction card details, the account information, the transaction amount, an identification code associated with the ATM 110b, a timestamp of the transaction, a transaction ID of the transaction, the authentication password, or the like. Based on the encrypted transaction details, the acquirer server 112 generates the first authorization request including the first and second data elements as described in conjunction with FIG. 3. In the present scenario, the first data element indicates $800.

The acquirer server 112 routes the first authorization request to the payment network server 114 (as shown by arrow 408). The transceiver 206 transmits the first authorization request to the issuer server 116 associated with the issuer bank (as shown by arrow 410) that corresponds to the user account of the user 102.

Based on the authentication password included in the first authorization request, the issuer server 116 authenticates the user 102. If the authentication of the user 102 is successful, the issuer server 116 determines the account balance or the available credit line linked to the user account that corresponds to the transaction. The issuer server 116 checks whether the account balance or the available credit line is sufficient to cover the transaction amount indicated by the first data element of the first authorization request. The exemplary scenario 400 illustrates the scenario where the issuer server 116 determines that the account balance or the available credit line does not cover the transaction amount. The issuer server 116 transmits the transaction decline notification to the payment network server 114 to indicate that the transaction has been declined (as shown by arrow 412). In a non-limiting example, it is assumed that the third data element of the transaction decline notification is an empty field.

The transceiver 206 receives the transaction decline notification from the issuer server 116. As the transaction is declined due to insufficient funds, the registration manager 210 identifies whether the user 102 has been registered for the overdraft service offered by the payment network. In a non-limiting example, it is assumed that the user 102 is registered for the overdraft service. The authorization manager 212 determines the overdraft amount for the transaction. In this example, the third data element is an empty field, thus, the overdraft amount is the same as the transaction amount (i.e., $800).

Upon determining the overdraft amount (i.e., $800), the authorization manager 212 retrieves a threshold value (i.e., “750”) from the list of threshold values (as described in FIG. 3) based on the overdraft amount. The authorization manager 212 then transmits the credit score request to the credit score database 118 to retrieve the credit score of the user 102 (as shown by arrow 414). The credit score database 118 transmits credit score information including the credit score (for example, “780”) of the user 102 to the payment network server 114 in response to the credit score request (as shown by arrow 416). The credit score comparator 214 compares the credit score with the retrieved threshold value (as shown by block 418a) and sets or resets the comparison flag based on the comparison, as described in conjunction with FIG. 3. In the present scenario, the credit score comparator 214 sets the comparison flag to ‘1’, as the credit score of the user 102 is greater than the retrieved threshold value. Thus, the user 102 qualifies for the overdraft service.

When the user 102 qualifies for the overdraft service, the authorization manager 212 modifies the first data element of the first authorization request (as shown by block 418b) and generates the second authorization request. In this scenario, the third data element of the transaction decline notification is an empty field, thus the first amount is the nominal amount (such as $0.01) defined by the payment network server 114. To modify the first data element, the authorization manager 212 replaces the transaction amount with the nominal amount. All other transaction details of the second authorization request, including the second data element, remain the same as those of the first authorization request.

The transceiver 206 transmits the second authorization request to the issuer server 116 (as shown by arrow 420). Based on the second authorization request, the issuer server 116 determines whether the account balance or the available credit line of the user account covers the first amount indicated by the first data element of the second authorization request. Since the account balance or the available credit line of the user account covers the first amount, the issuer server 116 approves the transaction. The issuer server 116 then transmits the transaction approval notification to the payment network server 114 indicating that the transaction is approved (as shown by arrow 422). The transaction approval notification overrides the transaction decline notification that was previously received by the transceiver 206. The authorization manager 212 further flags the transaction as the overdraft transaction. In one embodiment, when the transaction is flagged as the overdraft transaction, the authorization manager 212 modifies the credit score of the user 102 stored in the credit score database 118 in a way that the credit score becomes less than the lowest threshold value in the list of threshold values. In another embodiment, when the transaction is flagged as the overdraft transaction, the authorization manager 212 sets the overdraft flag (or the overdraft indicator) to ‘1’ for the user 102. The modified credit score or the overdraft flag (or the overdraft indicator), which is set to ‘1’, prevents the misuse of the overdraft service by the user 102.

The payment network server 114 routes the transaction approval notification to the acquirer server 112 by way of the transceiver 206 (as shown by arrow 424). The acquirer server 112 considers the transaction approval notification as the response of the first authorization request that the acquirer server 112 had transmitted to the payment network server 114. The acquirer server 112 then transmits the transaction approval notification to the ATM 110b (as shown by arrow 426). The user 102 is thus notified that the transaction is successful. The ATM 110b dispenses the cash equivalent to the transaction amount (i.e., $800), which is received by the user 102 (as shown by arrow 428).

As described in conjunction with FIG. 3, the authorization manager 212 transmits a message to the issuer server 116 for indicating that the transaction is the overdraft transaction and the user 102 is liable to maintain the transaction amount in the user account at the time of the settlement of the transaction. The message includes the schedule for settling the transaction indicating the time period after which the transaction will be settled by the payment network server 114. Further, if the user 102 attempts to avail the overdraft service for another transaction before the settlement of the previous overdraft transaction, the authorization manager 212 declines the privilege of availing the overdraft service to the user 102 based on one of the modified credit score, the overdraft flag, or the overdraft indicator.

The acquirer server 112 of the acquirer bank associated with the ATM 110b initiates the settlement of the transaction. To initiate the settlement, the acquirer server 112 transmits the settlement request to the payment network server 114. The payment network server 114 transmits the settlement request to the issuer server 116 as per the schedule. The issuer server 116 debits the transaction amount from the user account and notifies the payment network server 114. In one embodiment, when the payment network server 114 is notified that the user 102 has paid the transaction amount, the authorization manager 212 modifies the credit score of the user 102 stored in the credit score database 118 to restore its previous value, thereby making the user 102 eligible for the overdraft service. In another embodiment, when the payment network server 114 is notified that the user 102 has paid the transaction amount for settling the transaction, the authorization manager 212 resets the overdraft flag (or the overdraft indicator) to ‘0’ to indicate that the user 102 is again eligible for the overdraft service. The payment network server 114 communicates the settlement response to the acquirer server 112 indicating that the transaction amount is debited from the user account and transferred to the acquirer bank.

In one scenario, when the ATM 110b and the user account are associated with the same bank, the functionalities of the acquirer server 112 and the issuer server 116 may be performed by a single entity without deviating from the scope of the disclosure.

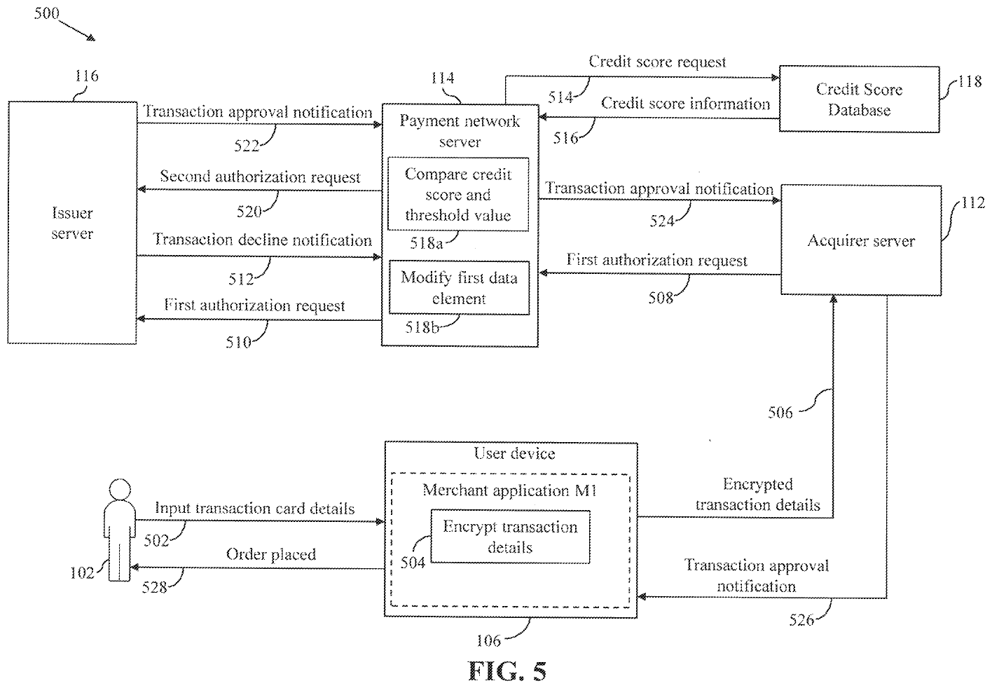

FIG. 5 is a block diagram that illustrates yet another exemplary scenario 500 for processing a declined transaction using the communication environment 100 of FIG. 1, in accordance with another embodiment of the present disclosure. The exemplary scenario 500 illustrates the user 102 who wants to perform an online transaction by way of the user device 106 for purchasing a product that is listed for sale on a merchant application ‘M1’ of the merchant 108.

To perform the online transaction for purchasing the product, the user 102 inputs the transaction card details of the transaction card 104 through an interface (such as an online payment gateway) presented on the user device 106 (as shown by arrow 502). In another scenario, the interface automatically retrieves the transaction card details of the transaction card 104 stored in the memory of the user device 106 based on a consent of the user 102. It will be apparent to a person having ordinary skill in the art that the user 102 may use other payment modes, such as a net-banking application, digital wallets, accepted by the merchant website or the merchant application. The online payment gateway is a gateway to the acquirer server 112 that encrypts the transaction details of the transaction (as shown by arrow 504) for communicating to the acquirer server 112. The acquirer server 112 receives the encrypted transaction details (as shown by arrow 506). The encrypted transaction details include the transaction card details, the transaction amount, the merchant identification code of the merchant 108, a timestamp of the transaction, a transaction ID of the transaction, the authentication password, or the like. Based on the encrypted transaction details, the acquirer server 112 generates the first authorization request including the first data element.

The acquirer server 112 routes the first authorization request to the payment network server 114 (as shown by arrow 508). The transceiver 206 transmits the first authorization request to the issuer server 116 (as shown by arrow 510). The issuer server 116 authenticates the user 102. If the authentication of the user 102 is successful, the issuer server 116 checks whether the account balance or the available credit line of the user account that corresponds to the transaction is sufficient to cover the transaction amount indicated by the first data element. The exemplary scenario 500 illustrates the scenario where the issuer server 116 determines that the account balance or the available credit line does not cover the transaction amount. The issuer server 116 transmits the transaction decline notification to the payment network server 114 to indicate that the transaction has been declined due to insufficient funds (as shown by arrow 512). In the present scenario, it is assumed that the issuer server 116 populates the third data element of the transaction decline notification with the available credit line linked to the user account.

The transceiver 206 receives the transaction decline notification from the issuer server 116. As the transaction is declined due to insufficient funds, the registration manager 210 identifies whether the user 102 has been registered for the overdraft service offered by the payment network. In a non-limiting example, it is assumed that the user 102 is registered for the overdraft service. The authorization manager 212 determines the overdraft amount for the transaction and retrieves a threshold value, which corresponds to the overdraft amount, from the list of threshold values stored in the memory 204. The authorization manager 212 then transmits the credit score request to the credit score database 118 to retrieve the credit score of the user 102 (as shown by arrow 514). The credit score database 118 transmits credit score information including the credit score of the user 102 to the payment network server 114 in response to the credit score request (as shown by arrow 516). The credit score comparator 214 compares the credit score with the retrieved threshold value (as shown by block 518a) and sets or resets the comparison flag based on the comparison (as described in FIGS. 3 and 4). In the present scenario, it is assumed that the credit score comparator 214 sets the comparison flag to ‘1’ and the user 102 qualifies for the overdraft service.

When the user 102 qualifies for the overdraft service, the authorization manager 212 modifies the first data element of the first authorization request based on the first amount (as shown by block 518b) and generates the second authorization request. The generation of the second authorization request is explained in FIGS. 3 and 4. In this scenario, the first amount is equivalent to the available credit line of the user account. All other transaction details of the second authorization request, including the second data element, remain the same as those of the first authorization request.

The transceiver 206 transmits the second authorization request to the issuer server 116 (as shown by arrow 520). Based on the second authorization request, the issuer server 116 checks whether the account balance or the available credit line of the user account covers the amount indicated by the first data element of the second authorization request. Since the account balance or the available credit line of the user account covers the first amount indicated by the first data element, the issuer server 116 approves the transaction. The issuer server 116 then transmits the transaction approval notification to the payment network server 114 indicating that the transaction is approved (as shown by arrow 522). The transaction approval notification overrides the transaction decline notification that the transceiver 206 had previously received. The authorization manager 212 further flags the transaction as the overdraft transaction.

The payment network server 114 routes the transaction approval notification to the acquirer server 112 by way of the transceiver 206 (as shown by arrow 524). The acquirer server 112 considers the transaction approval notification as a response to the first authorization request that the acquirer server 112 had transmitted to the payment network server 114. The acquirer server 112 then transmits the transaction approval notification to the user device 106 (as shown by arrow 526) by way of the online payment gateway. The user 102 is thus notified that the transaction is successful and the order for the product is placed at the merchant application ‘M1’ (as shown by arrow 528).

As described in conjunction with FIG. 3, the authorization manager 212 transmits a message to the issuer server 116 for indicating that the transaction is the overdraft transaction and the user 102 is liable to maintain the transaction amount in the user account at the time of the settlement of the transaction. The message includes the schedule for settling the transaction indicating the time period after which the transaction will be settled. The settlement of the transaction in the present scenario is carried out as described in conjunction with FIGS. 3 and 4.

In one embodiment, if the payment network and the issuer bank have an agreement therebetween, the payment network server 114 approves the transaction if the transaction is declined due to downtime of the issuer server 116. The payment network server 114 approves the transaction for the nominal amount and the actual transaction amount is settled once the downtime of the issuer server 116 is over. The settlement of the actual transaction amount is the same as explained in the foregoing in FIGS. 3 and 4.

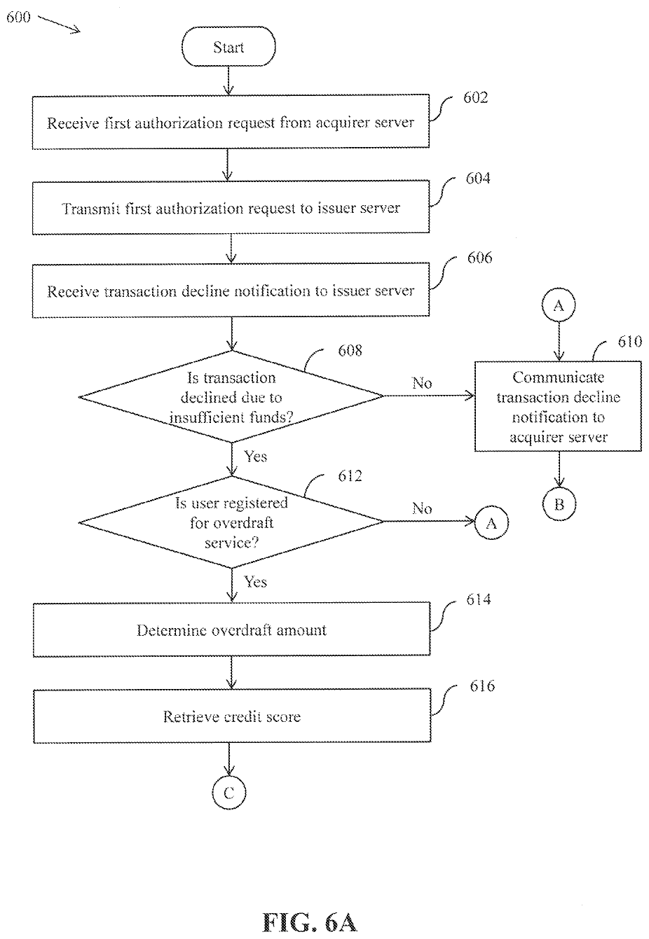

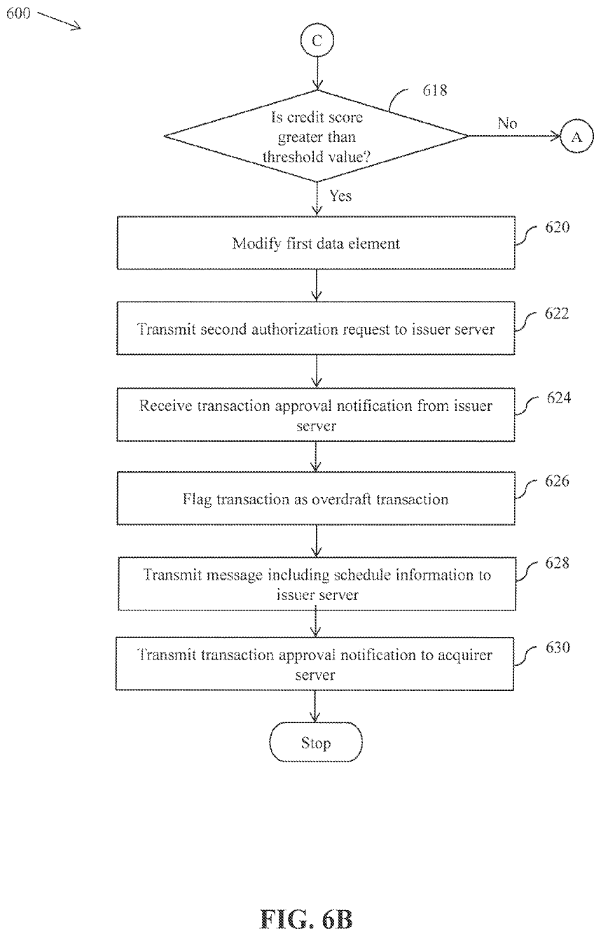

FIGS. 6A and 6B, collectively represent a flow chart 600 that illustrates the method for processing declined transactions, in accordance with an embodiment of the present disclosure.

At step 602, the payment network server 114 receives the first authorization request from the acquirer server 112. At step 604, the payment network server 114 transmits the first authorization request to the issuer server 116. The issuer server 116 determines whether the account balance or the available credit line linked to the user account that corresponds to the transaction covers the transaction amount indicated by the first authorization request. If the account balance or the available credit line covers the transaction amount, the issuer server 116 approves the transaction. If the account balance or the available credit line does not cover the transaction amount, the issuer server 116 declines the transaction and transmits the transaction decline notification to the payment network server 114.

At step 606, the payment network server 114 receives the transaction decline notification from the issuer server 116 indicating that the transaction has been declined. At step 608, the authorization manager 212 checks whether the transaction is declined due to insufficient funds. If at step 608, it is determined that the transaction is declined for a reason other than insufficient funds, step 610 is performed. At step 610, the payment network server 114 communicates the transaction decline notification to the acquirer server 112 to indicate that the transaction has been declined and the user 102 is notified accordingly. If at step 608, it is determined that the transaction is declined due to insufficient funds, step 612 is performed. At step 612, the registration manager 210 checks whether the user 102 is registered for the overdraft service. If at step 612, it is determined that the user 102 is not registered for the overdraft service, step 610 is performed. If at step 612, it is determined that the user 102 is registered for the overdraft service, step 614 is performed.

At step 614, the authorization manager 212 determines the overdraft amount based on the transaction amount and the amount indicated by the third data element of the transaction decline notification. At step 616, the authorization manager 212 retrieves the credit score of the user 102 from the credit score database 118. At step 618, the credit score comparator 214 checks whether the credit score is greater than or equal to the threshold value that corresponds to the overdraft amount. If at step 618, it is determined that the credit score is less than the corresponding threshold value, step 610 is performed. If at step 618, it is determined that the credit score is greater than or equal to the threshold value, step 620 is performed.

At step 620, the authorization manager 212 modifies the first data element of the first authorization request to generate the second authorization request. The authorization manager 212 modifies the first data element such that the modified first data element indicates the first amount that is lower than the transaction amount. In one scenario, the first amount is the account balance or the available credit line linked to the user account of the user 102. In another scenario, the first amount is the nominal amount defined by the payment network. At step 622, the payment network server 114 transmits the second authorization request to the issuer server 116. At step 624, the payment network server 114 receives the transaction approval notification from the issuer server 116. At step 626, the authorization manager 212 flags the transaction as the overdraft transaction. At step 628, the payment network server 114 transmits the message including the schedule for settling the transaction to the issuer server 116. At step 630, the payment network server 114 transmits the transaction approval notification to the acquirer server 112 to indicate that the transaction is successful.

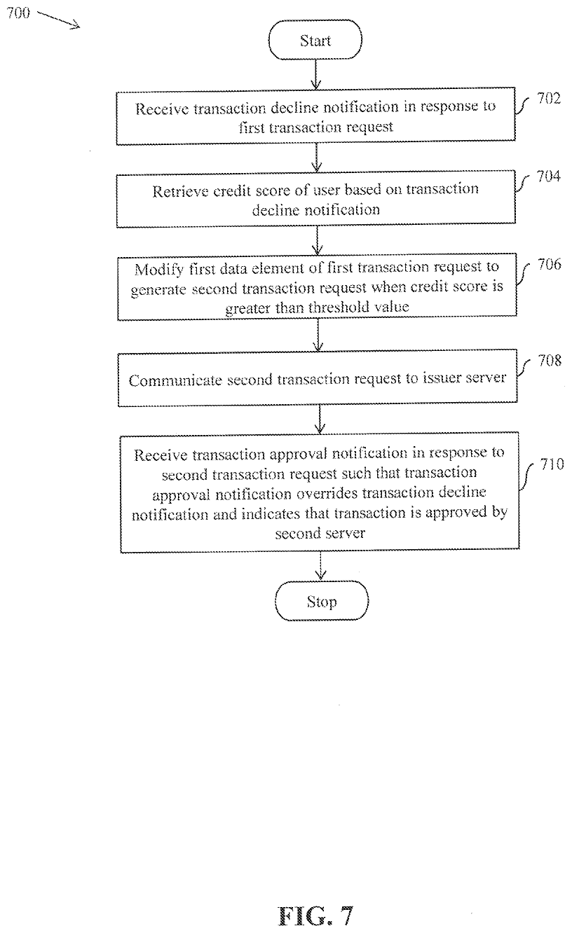

FIG. 7 is a high-level flow chart 700 that illustrates the method for processing declined transactions, in accordance with an embodiment of the present disclosure. At step 702, a first server (such as the payment network server 114) receives the transaction decline notification in response to the first authorization request that was communicated to a second server (such as the issuer server 116) for approving the transaction performed by the user 102. The first authorization request includes the first data element that indicates a transaction amount of the transaction. The transaction decline notification indicates that the transaction has been declined by the second server. At step 704, the first server retrieves the credit score of the user 102 from a database (such as the credit score database 118) based on the transaction decline notification. At step 706, the first server modifies the first data element of the first authorization request to generate the second authorization request when the credit score of the user 102 is greater than or equal to the corresponding threshold value. The modified first data element indicates a first amount that is lower than the transaction amount. At step 708, the first server communicates the second authorization request to the second server. At step 710, the first server receives the transaction approval notification from the second server in response to the second authorization request. The transaction approval notification overrides the transaction decline notification and indicates that the transaction is approved by the second server, thereby making the transaction successful.

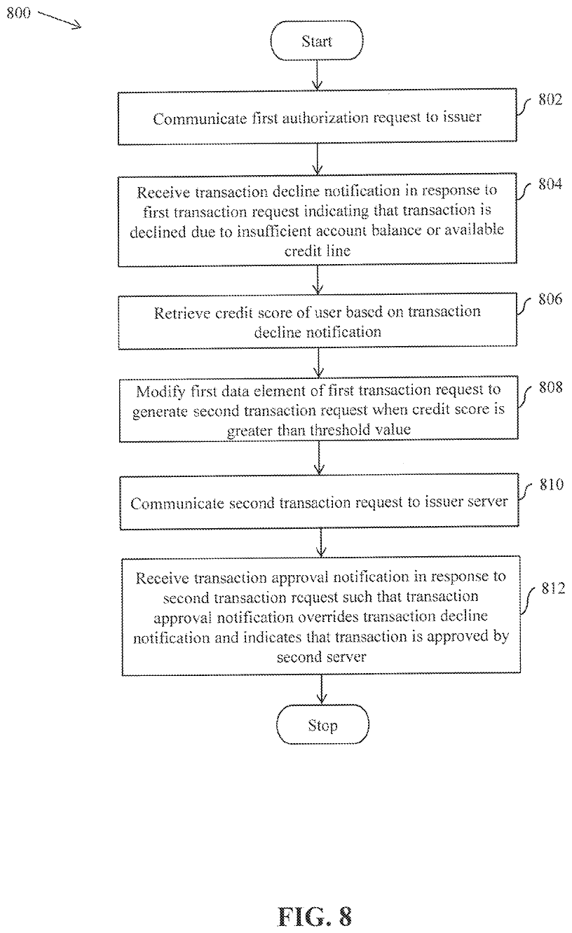

FIG. 8 is a high-level flow chart 800 that illustrates the method for processing declined transactions, in accordance with another embodiment of the present disclosure. At step 802, a first server (such as the payment network server 114) communicates the first authorization request for the transaction performed by the user 102 to a second server (such as the issuer server 116). The first authorization request includes the first data element that indicates a transaction amount of the transaction. At step 804, the first server receives the transaction decline notification in response to the first authorization request from the second server indicating that the transaction is declined due to insufficient account balance or available credit line of the user account that corresponds to the transaction. At step 806, the first server retrieves the credit score of the user 102 from a database (such as the credit score database 118) based on the transaction decline notification. At step 808, the first server modifies the first data element of the first authorization request to generate the second authorization request when the credit score of the user 102 is greater than or equal to the corresponding threshold value. The modified first data element indicates the first amount that is lower than the transaction amount. At step 810, the first server communicates the second authorization request to the second server. At step 812, the first server receives the transaction approval notification from the second server in response to the second authorization request. The transaction approval notification indicates that the transaction is approved by the second server and overrides the transaction decline notification, thereby making the transaction successful.

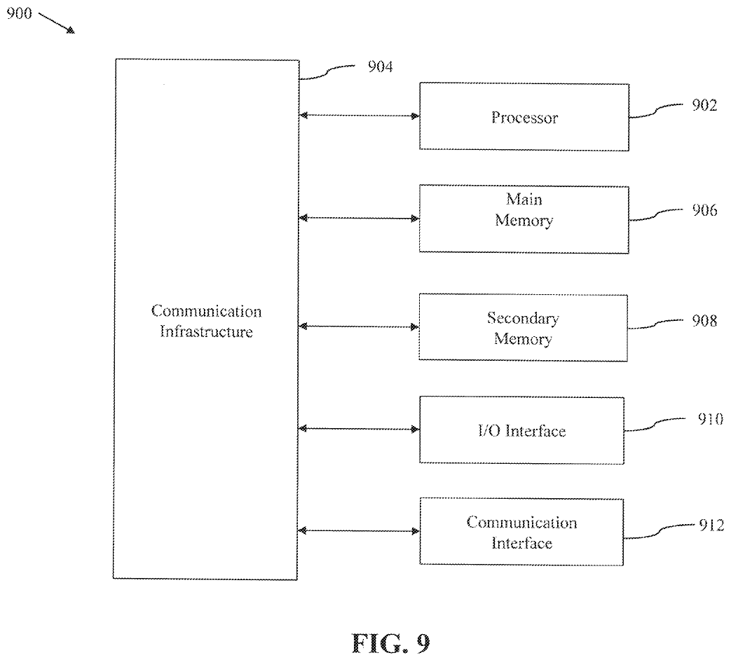

FIG. 9 is a block diagram that illustrates system architecture of a computer system 900, in accordance with an embodiment of the present disclosure. An embodiment of the present disclosure, or portions thereof, may be implemented as computer readable code on the computer system 900. In one example, the user device 106, the first and second terminal devices 110a and 110b, the acquirer server 112, the payment network server 114, and the issuer server 116 of FIG. 1 may be implemented in the computer system 900 using hardware, software, firmware, non-transitory computer readable media having instructions stored thereon, or a combination thereof, and may be implemented in one or more computer systems or other processing systems. Hardware, software, or any combination thereof, may embody modules and components used to implement the methods of FIGS. 6A and 6B, 7, and 8.

The computer system 900 includes a processor 902 that may be a special-purpose or a general-purpose processing device. The processor 902 may be a single processor, multiple processors, or combinations thereof. The processor 902 may have one or more processor cores. In one example, the processor 902 is an octa-core processor. Further, the processor 902 may be connected to a communication infrastructure 904, such as a bus, i.e., the bus 208, message queue, multi-core message-passing scheme, and the like. The computer system 900 may further include a main memory 906 and a secondary memory 908. Examples of the main memory 906 may include RAM, ROM, and the like. In one embodiment, the main memory 906 is the memory 204. The secondary memory 908 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 900 further includes an input/output (I/O) interface 910 and a communication interface 912. The I/O interface 910 includes various input and output devices that are configured to communicate with the processor 902. Examples of the input devices may include a keyboard, a mouse, a joystick, a touchscreen, a microphone, and the like. Examples, of the output devices may include a display screen, a speaker, headphones, and the like. The communication interface 912 may be configured to allow data to be transferred between the computer system 900 and various devices that are communicatively coupled to the computer system 900. Examples of the communication interface 912 may include a modem, a network interface, i.e., an Ethernet card, a communications port, and the like. Data transferred via the communication interface 912 may correspond to signals, such as electronic, electromagnetic, optical, or other signals as will be apparent to a person skilled in the art. The signals may travel via a communications channel (not shown) which may be configured to transmit the signals to devices that are communicatively coupled to the computer system 900. Examples of the communications channel may include, but are not limited to, cable, fiber optics, a phone line, a cellular phone link, a radio frequency link, and the like.

Computer program medium and computer usable medium may refer to memories, such as the main memory 906 and the secondary memory 908, which may be a semiconductor memory such as a DRAM. These computer program mediums may provide data that enables the computer system 900 to implement the methods illustrated in FIGS. 6A and 6B, 7, and 8. In an embodiment, the present disclosure is implemented using a computer implemented application, the computer implemented application may be stored in a computer program product and loaded into the computer system 900 using the removable storage drive or the hard disc drive in the secondary memory 908, the I/O interface 910, or communication interface 912.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 902, and a memory, such as the main memory 906, and the secondary memory 908 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the communication environment 100 enables an account holder (such as user 102) to avail the overdraft service. The account holder is able to make a purchase or withdraw cash from the associated account in spite of having an insufficient account balance or available credit line without facing the inconvenience of a declined transaction. In case of an emergency, if the account holder is falling short of funds to perform the transaction, the account holder can avail the overdraft service without any hassle. Thus, the number of declined transactions due to insufficient funds is reduced, thereby reducing a processing overhead for the payment networks. As the processing of the declined transactions is transparent to the account holder, transaction experience of the account holder is improved. Since the credit score of the account holders is checked before providing the overdraft service, only reliable account holders are allowed to avail the overdraft service. Thus, a risk of incurring a loss for the issuer bank in case the account holder fails to pay the overdraft amount, is reduced.

Techniques consistent with the present disclosure provide, among other features, systems and methods for processing declined transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for processing declined transactions, the method comprising:
receiving, by a first server from a second server, a transaction decline notification in response to a first authorization request that is communicated to the second server for approving a transaction performed by a user, wherein the first authorization request includes a first data element that indicates a transaction amount of the transaction, and wherein the transaction decline notification indicates that the transaction is declined;
retrieving, by the first server, a credit score of the user from a database based on the transaction decline notification;
modifying, by the first server, the first data element of the first authorization request to generate a second authorization request for the transaction, when the credit score is greater than a threshold value, wherein the modified first data element indicates a first amount that is lower than the transaction amount;
communicating, by the first server, the second authorization request to the second server; and
receiving, by the first server, a transaction approval notification from the second server in response to the second authorization request, wherein the transaction approval notification overrides the transaction decline notification and indicates that the transaction is approved by the second server, thereby making the transaction successful.

2. The method of claim 1, further comprising communicating, by the first server to the second server, the first authorization request when the transaction is performed by the user.

3. The method of claim 1, wherein the second server declines the transaction when an account balance of an account that corresponds to the transaction or an available credit line linked to the account, is less than the transaction amount.

4. The method of claim 3, wherein the transaction decline notification includes a second data element that indicates the account balance or the available credit line.

5. The method of claim 4, wherein the first amount is one of the account balance, the available credit line, or an amount defined by the first server that is independent of the account balance or the available credit line.

6. The method of claim 1, further comprising communicating, by the first server to the second server, a message indicating a schedule for settling the transaction for the transaction amount.

7. The method of claim 1, further comprising flagging, by the first server, the transaction as an overdraft transaction based on the modification of the first data element.

8. The method of claim 1, wherein the first server is one of a payment network server or a payment processing server.

9. A system for processing declined transactions, the system comprising a first server, the first server having a processor configured to:
receive, from a second server, a transaction decline notification in response to a first authorization request that is communicated to the second server for approving a transaction performed by a user, wherein the first authorization request includes a first data element that indicates a transaction amount of the transaction, and wherein the transaction decline notification indicates that the transaction is declined;
retrieve a credit score of the user from a database based on the transaction decline notification;
modify the first data element of the first authorization request to generate a second authorization request for the transaction, when the credit score is greater than a threshold value, wherein the modified first data element indicates a first amount that is lower than the transaction amount;
communicate the second authorization request to the second server; and
receive a transaction approval notification from the second server in response to the second authorization request, wherein the transaction approval notification overrides the transaction decline notification and indicates that the transaction is approved by the second server, thereby making the transaction successful.

10. The system of claim 9, wherein the second server is configured to decline the transaction when an account balance of an account that corresponds to the transaction or an available credit line linked to the account is less than the transaction amount.

11. The system of claim 10, wherein the transaction decline notification includes a second data element that indicates the account balance or the available credit line.

12. The system of claim 11, wherein the first amount is one of the account balance, the available credit line, or an amount defined by the first server that is independent of the account balance or the available credit line.

13. The system of claim 9, wherein the processor is further configured to communicate to the second server, a message indicating a schedule for settling the transaction for the transaction amount.

14. The system of claim 9, wherein the processor is further configured to flag the transaction as an overdraft transaction based on the modification of the first data element.

15. The system of claim 9, wherein the first server is one of a payment network server or a payment processing server.

16. A computer-implemented method for processing declined transactions, the method comprising:
communicating, by a payment network server to an issuer server, a first authorization request for a transaction performed by a user, wherein the first authorization request includes a first data element that indicates a transaction amount of the transaction;
receiving, by the payment network server from the issuer server, a transaction decline notification in response to the first authorization request, wherein the transaction decline notification indicates that the transaction is declined due to an insufficient account balance or an insufficient available credit line of an account that corresponds to the transaction;
retrieving, by the payment network server, a credit score of the user from a database based on the transaction decline notification;
modifying, by the payment network server, the first data element of the first authorization request to generate a second authorization request for the transaction, when the credit score is greater than a threshold value, wherein the modified first data element indicates a first amount that is lower than the transaction amount;
communicating, by the payment network server, the second authorization request to the issuer server; and
receiving, by the payment network server, a transaction approval notification from the issuer server in response to the second authorization request, wherein the transaction approval notification indicates that the transaction is approved by the issuer server and overrides the transaction decline notification, thereby making the transaction successful.

17. The method of claim 16, wherein the transaction decline notification includes a second data element that indicates the account balance or the available credit line.

18. The method of claim 17, wherein the first amount is one of the account balance, the available credit line, or an amount defined by the server that is independent of the account balance or the available credit line.

19. The method of claim 16, further comprising communicating, by the payment network server to the issuer server, a message indicating a schedule for settling the transaction for the transaction amount.

20. The method of claim 16, further comprising flagging, by the payment network server, the transaction as an overdraft transaction based on the modification of the first data element.
